(19) United States
(12) Patent Application Publication
(10) Pub. No.: US 2002/0019218 A1
(43) Pub. Date: Feb. 14, 2002

(54) RADIOTELEPHONE TERMINAL TRANSMITTER AND CORRESPONDING TERMINAL

(76) Inventors: FRANCK GREVERIE, PARIS (FR); EMILE SARRAZIN, SUR FORET (FR)

Correspondence Address: SUGHRUE MION ZINN MACPEAK & SEAS, 2100 PENNSYLVANIA AVENUE NW SUITE 800, WASHINGTON, DC, 200373702

(21) Appl. No.: 09/163,056

(22) Filed: Sep. 30, 1998

(30) Foreign Application Priority Data
Oct. 2, 1997 (FR) 9712261

(51) Int. Cl. H04B 1/04; H01Q 11/12; H04M 1/00; H04B 1/38

(52) U.S. Cl. 455/127

(57) ABSTRACT

A transmitter for user portable radiotelephone terminals includes an amplifier, an arrangement for controlling the output power level of the amplifier and an arrangement for controlling the power level of the radio frequency input signal supplied to the amplifier. It is therefore able to position the operating point of the amplifier near or at the limit between its linear operating area and its saturation operating area.

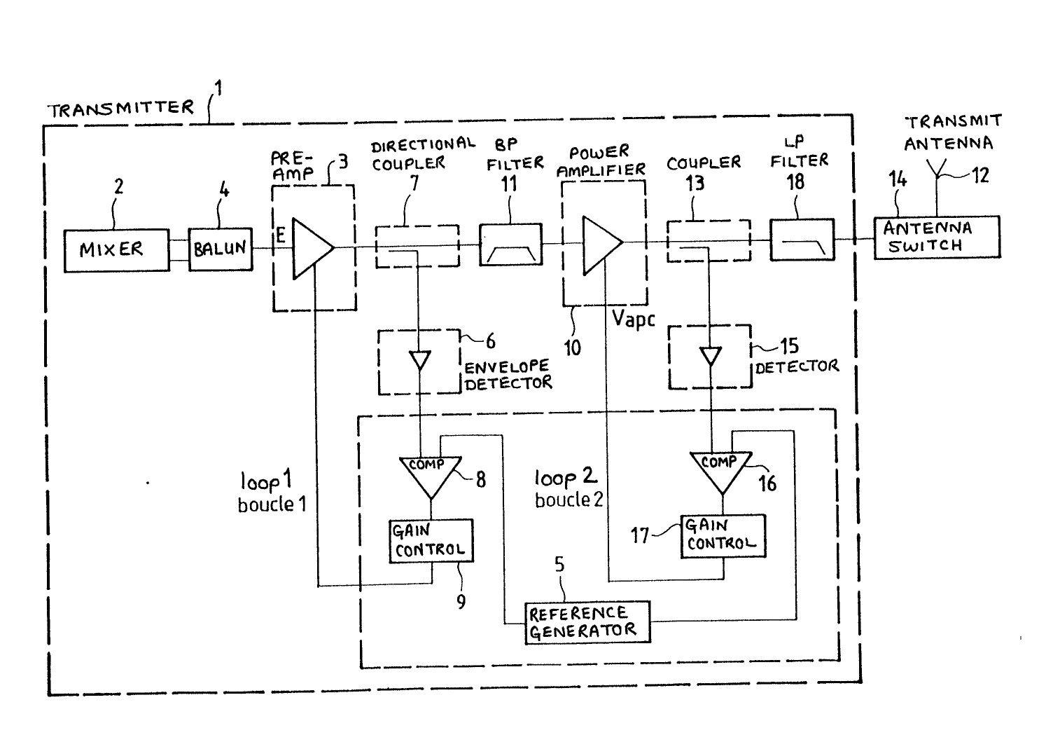

### BACKGROUND OF THE INVENTION

1. Field of the Invention

The invention concerns a radio transmitter and more particularly a transmitter for a user portable radiotelephone terminal.

2. Description of the Prior Art

A problem that has come to light with the expansion of radiotelephone communications between portable terminals using at least one station of a mobile radio network such as a GSM-DCS-PCS network is assuring strict compliance with emission standards imposed on the terminals to prevent terminals producing unwanted transmissions at frequencies above those allocated to them for transmission and in particular unwanted transmissions in the reception band. Given the number of terminals that have been sold, such unwanted transmissions could have extremely negative consequences in terms of the quality of calls set up.

Existing technology provides effective channel filtering to prevent emission of unwanted signals when a transmitter incorporates an intermediate frequency mixer and even when the transmitter incorporates an insufficiently linear power amplifier, in which case the filtering is preferably performed at the output of the intermediate frequency mixer.

Such means entail costs that terminal manufacturers seek to reduce. In particular, transmitters are made with a nil intermediate frequency where the channel filtering possibilities are in the base band and therefore a great distance upstream of the power amplifier and the antenna fed by the power amplifier.

Document FR-A-2726410 describes a mobile terminal transmitter in which the power amplifier for amplifying radio frequency signals to be transmitted has a control loop such that the amplifier can be operated as close as possible to saturation to improve its efficiency. However, this is not a total solution to the problem mentioned above in that, depending on the power level of the input signal applied to the power amplifier, the real operating point of the amplifier can depart from the operating point imposed by the loop and this can lead to unacceptable operation of the transmitter.

### SUMMARY OF THE INVENTION

The invention therefore proposes a transmitter for a radiotelephone terminal and in particular a user portable terminal.

The transmitter has a power amplifier at its output and means for controlling this amplifier to impose on it an operating point near or at the limit between the linear operation area and the saturation operation area.

To be able to position and fix the operating point of the amplifier as close as possible to saturation, the transmitter includes means for controlling the power level of the radio frequency input signal to said amplifier.

The invention, its features and its advantages are explained in the following description with reference to the accompanying drawing.

### BRIEF DESCRIPTION OF THE DRAWING

The single figure is a block schematic of a mobile radiotelephone terminal transmitter.

### DETAILED DESCRIPTION OF THE PREFERRED EMBODIMENTS

The transmitter 1 shown in the single figure is designed to be incorporated into a radiotelephone terminal and more particularly a portable user terminal for a mobile radio network, for example a portable terminal of a GSM, DCS or PCS mobile radio system.

As indicated hereinabove, the transmitter 1 is designed to minimize the generation of unwanted signals at frequencies above those allocated to the user terminals for transmission. It consequently reduces filtering prior to transmission, which is usually indispensable to prevent a transmitter generating bothersome unwanted signals.

Transmissions by mobile radio network users comprise, on the one hand, communication signals, which are digital signals in the mobile radio networks referred to above and which correspond to signals, in particular voice signals, that the user wishes to transmit to another user via their mobile radio terminal and, on the other hand, signaling which can or must accompany these communication signals.

The latter are fed to an input circuit 2, usually of the mixer type as shown here, enabling them to be associated in the form of modulation with a radio frequency carrier signal at a particular frequency to constitute a transmission subsystem input signal.

The modulated signal obtained is passed to a signal input E of a pre-amplifier 3 via a matching transformer 4 which is usually of the “BALUN” type (this is well known to the skilled person).

There is provision for dynamically controlling the output power of the pre-amplifier 3 which receives the input signal as defined hereinabove. The control input of the pre-amplifier is therefore included in a control loop responsive to the power level of the signal supplied by the pre-amplifier 3 and an indication supplied by a reference generator 5. The signal level at the output of the pre-amplifier 3 is conventionally supplied by an envelope detector 6 connected to the output of the pre-amplifier by a directional coupler 7. The envelope detector 6 is a detector based on SCHOTTKY diodes, for example, and the directional coupler 7 is a ceramic component or a simple capacitive coupler, for example.

The power level of the signal obtained at the output of the detector 6 is compared to a reference value supplied by the reference generator 5 under the control of a logic device, not shown, which is part of the terminal. This logic device is possibly of the hardwired logic type or an appropriately programmed processor included in the terminal. The logic device is not shown in the single figure, which shows only the transmitter 1, an antenna switch and an antenna. Hardware and/or software means symbolized by a comparator 8 receive on the one hand the signal level supplied by the detector 6 and on the other hand the reference from the reference generator 5. The output signal of the comparator 8 is applied to a gain control circuit 9 which controls the pre-amplifier 3. In a manner known to the skilled person, this allows the operating point of the amplifier, and more particularly the power level of the output signal that it produces from the input signal it receives, to be fixed.

The output signal of the pre-amplifier 3 is fed to a signal input E1 of a power amplifier 10 at the output of the transmitter 1 via a band-pass filter 11.

The control loop based on the pre-amplifier 3 and including the coupler 7, the detector 6, the comparator 8 and the gain control circuit 9 enables a constant power to be applied to the input of the power amplifier 10 regardless of the transmission frequency in the pass-band of the transmitter, the temperature and the parameter spread of components upstream of the power amplifier.

Each terminal can have its transmitter adjusted, either automatically during manufacture or manually in the laboratory, so that the power level at the power amplifier input is always the same. It is also possible to optimize the power necessary at the power amplifier input by specifically adjusting the level for each power weight, the various weights corresponding to different control voltages Vapc.

The power amplifier 10 is dynamically controlled by means of a control loop that operates on the control input Vapc of the amplifier, which can be the gate and/or the power drain. The loop is responsive to the power level of the signal appearing at the amplifier output to be passed to a transmit antenna 12. A coupler 13 corresponding to a coupler 7 is inserted into the path between the output of the power amplifier 10 and an antenna switch 14 through which the antenna 12 is energized during transmission.

There is a low-pass or band-stop filter 18 eliminating unwanted transmissions corresponding to harmonics of the signal to be transmitted at the output of the power amplifier 10, upstream of the antenna switch 14 and downstream of the coupler 13 in the example shown.

A detector 15 corresponding to the detector 6 determines the power level of the signal appearing at the output of the power amplifier 10 for use by means symbolized here by a comparator 16 and corresponding functionally to the means symbolized by the comparator 8. The signal obtained at the output of the comparator 16 from the power level determined by the detector 15 and a reference value supplied by the reference generator 5 is applied to a gain control circuit 17 which operates on the control input Vapc of the power amplifier 10 in a similar manner to that mentioned above in connection with the pre-amplifier 3.

The pre-amplifier 3 controls the level of the signal supplied at the input of the power amplifier 10 and assures a constant signal level at this input, which favors correct functioning of the power amplifier without deviation from the operating point fixed for it by the gain control circuit 17, especially when the amplifier is operating at the limit between its linear and saturation areas of operation, as required.

Operation at the 1 dB compression point is optimized from the performance point of view with an acceptable compromise between efficiency and nonlinearity, regardless of environmental conditions and the level of the control voltage Vapc.

The combination of control loops including the gain control circuits 9 and 17 achieves great accuracy in the positioning of the operating point of the power amplifier point 10. It also reduces filtering in the transmission subsystem and in particular that provided by the filters 11 and 18. In a conventional system without accurate control of the power amplifier operating point the filter 18 attenuates unwanted transmissions in the receive band and power amplifier harmonics.

As the receive band is very close to the transmit band, with a band gap of 10 MHz or 20 MHz, for example, the filter 18 must be powerful and this increases insertion losses downstream of the power amplifier 10. If the amplifier operating point is not determined precisely it is essential to apply to this amplifier an input power higher than that which would normally be necessary under nominal operating conditions to assure correct operation even under unfavorable conditions. The effect of the surplus input power is to increase unwanted transmissions in the receive band when operating conditions are nominal and therefore implies more severe filtering by the filter 18.

The improved accuracy obtained with the invention therefore allows requirements at the level of the filters 11 and 18 to be relaxed.

This combination of control circuits is also particularly interesting when there is no duplexer to connect the transmitter 1 to the transmit antenna 12, as in the example described here. It is then possible to reduce the consumption of the transmitter and the output power of the power amplifier 10 of the transmitter accordingly.

There is claimed:

1. A transmitter, in particular for radiotelephone terminals, including a power amplifier at its output and means for controlling said amplifier so as to impose on it an operating point near or at the limit between its linear operating area and its saturation operating area, and means for controlling the power level of the radio frequency input signal supplied to said amplifier in order to be able to position said operating point thereof.

2. The transmitter claimed in claim 1 wherein said means for controlling the power level of said radio frequency input signal supplied to said power amplifier at the output of said transmitter comprise a gain control loop including means for measuring the power level of said radio frequency signal to be fed to said amplifier, gain control means operating on a pre-amplifier upstream of the radio frequency input of said power amplifier and comparator means operating on said gain control means in accordance with indications that it receives from said power level measuring means and from reference supplier means, respectively.

3. A user radiotelephone terminal including a transmitter according to any one of the preceding claims adapted to operate near or at the limit between its linear operation area and its saturation operation area with a minimum of unwanted transmissions.
